(19) United States
(12) Patent Application Publication
(10) Pub. No.: US 2011/0003142 A1
(43) Pub. Date: Jan. 6, 2011

(54) NANOPARTICLE SOL-GEL COMPOSITE HYBRID TRANSPARENT COATING MATERIALS

(75) Inventors: Masahiro Asuka, Osaka (JP); Wolfgang M. Sigmund, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: University of Florida Research Foundation, Inc., Gainesville, FL (US)

(21) Appl. No.: 12/920,790

(22) PCT Filed: Mar. 3, 2009
(86) PCT No.: PCT/US09/35864

§ 371 Date: Sep. 2, 2010

Related U.S. Application Data
(60) Provisional application No. 61/033,142, filed on Mar. 3, 2008.

(51) Int. Cl. B32B 5/16; B05D 3/12; B05D 1/40; B05D 3/02

(52) U.S. Cl. 428/329; 427/331; 427/356; 427/240; 427/359; 427/368; 427/397.7; 428/323; 428/328; 977/775

(57) ABSTRACT

A composite hybrid coating having a thick highly transparent hard coating with excellent barrier properties is described. The hybrid coating is the gelled dispersion of nanoparticles in a sol with least one hydrolyzable silane and at least one hydrolyzable metal oxide precursor. In one embodiment a composite hybrid coating is formed by the curing of a dispersion formed by the addition of a suspension of boehmite nanoplatelets in a sol prepared by the hydrolysis of tetraethoxysilane, γ-glycidoxypropyltrimethoxysilane and titanium tetrabutoxide in ethanol. A plastic substrate can be coated with the dispersion and the dispersion gelled to a thickness of at least 5 μm with heating to less than 150° C.

### BACKGROUND OF THE INVENTION

Although plastics have been used for transparent articles and are superior to glass equivalents with regard to many material properties, there are a number of physical property shortcomings that limit many of their applications. One shortcoming is the hardness of the plastic, which being soft is often prone to scratching. Another shortcoming is that plastics can be rather poor barriers to water or other chemicals and gases. For many developing technologies, such as organic solar cells, liquid crystal displays (LCDs), and organic light emitting diodes (LEDs), encapsulants and coatings with very low permeability of water and oxygen are needed.

Hard coats are transparent films often applied to some plastics to improve their hardness, resistance to chemicals and/or gas barrier properties. Silicone hardcoats are a type of hard coat prepared by a sol-gel process. Typical coating procedures used to make silicone hardcoated polycarbonate or other polymeric articles are shown by Burzynski et al., U.S. Pat. No. 3,451,838, Gagnon, U.S. Pat. No. 3,707,397, Clark, U.S. Pat. No. 3,986,997, Clark, U.S. Pat. No. 4,027,073, Goossens et al., U.S. Pat. No. 4,242,381, Olson et al., U.S. Pat. No. 4,284,685 and Patel, U.S. Pat. No. U.S. Pat. No. 5,041,313 Gillette et al., U.S. Pat. No. 5,384,159. Such coatings typically require a primer coating between the plastic and the hardcoat and are baked at moderate temperatures, for example 125° C., for up to about an hour to result in a relatively hard surface to protect the plastic from chemicals and scratches. Although relatively hard, such sol-gel derived coatings are not hard or durable when compared to typical inorganic glasses. On polymeric substrates, the curing temperatures for such coatings are limited by the thermal transition temperatures of the polymer substrate, such as the glass transition and the melting point.

Transparent coatings, by sol-gel techniques, that more closely approximate inorganic glasses often have a tendency to crack because of shrinkage induced stresses upon evaporation of solvents and the loss of condensation byproducts, such as alcohols. Because of this propensity for cracking, coating thicknesses in excess of 1.5 μm generally require that multiple thin coating layers are made, usually with practical limits of 20 to 30 coats. Such thick coatings by multiple layers are generally not flexible. The formation of thick single layer coatings is often achieved by the use of an inorganic/organic composite, an organically modified ceramic, where an organic component is included in a colloidal sol-gel system. Generally there is little interpenetration of these inorganic and organic portions, and high hardness with optical transparency is seldom achieved in such systems.

Recently, the inclusion of nanoparticles to form photocurable coating compositions that result in an enhanced scratch resistance while having a high optical transparency has been disclosed. Bier et al., U.S. Pat. No. 7,250,219, discloses the polycondensation of a silylacrylate with nanoscale Al(O)OH particles as a possible constituent, followed by the UV irradiation of a photoinitiator to form a coating. Walker, Jr. et al., U.S. Pat. No. 7,264,872, discloses a UV curable composition of containing acrylate and methacrylate surface modified nanoparticles of zirconia for the formation of a durable anti-reflective coating with other UV curable monomers and oligomers. Kasemann et al., U.S. Pat. No. 6,482,525, discloses the inclusion of a boehmite sol with methacryloxypropytrimethylsilane for a UV curing system that can be directly applied to most plastic substrates. Examples in Kasemann et al. indicate that a low level haze is observed in such coatings.

A thermally cured transparent coating that has large and nanosized ceramic particles with high abrasion resistance and a high index of refraction is disclosed in Singhal et al., U.S. Pat. No. 6,939,908. The coating composition can include an epoxy, methacrylate, or amino functional silane or titanate with relatively large alumina nanoparticles and relatively small ceramic particles that can be any of a number of different metal oxides, nitrides, or carbides or even diamond. Ultimately, the coating has a high proportion of ceramic nanoparticles that can be in excess of 90% of the cured coating. To form coatings with these nanoparticles, processing is carried out from very low solids dispersions or solutions. Although no processing temperatures are disclosed, the process requires evaporation in vacuum to achieve the coating.

As the use of organic polymer based devices, such as LCD displays and LED lighting, increases, there is a greater need for thick superior abrasive resistant transparent coatings that have excellent barrier properties for plastic or other organic substrates, and where the processing can be carried out with the formation of a single coating layer in a manner that does not damage the underlying substrate. Hence the formation of a transparent hard coating with high solids that act as an excellent diffusion barrier for an underlying substrate remains a need.

### BRIEF SUMMARY OF THE INVENTION

An embodiment of the invention is a transparent composite hybrid coating that has dispersed nanoparticles of less than 100 nm in diameter in a sol-gel glass derived from a mixture including at least one hydrolyzable silane, where at least one of the silanes contains a non-hydrolyzable organic group with a polymerizable functionality, and at least a one hydrolyzable metal oxide precursor. By controlling the proportions of the silanes and hydrolyzable metal oxide precursor, carrying out the hydrolysis in solution of the less reactive silanes before inclusion of the hydrolyzable metal oxide precursor, and dispersing the nanoparticles in the sol solution, a thick coating, greater than 5 μm in thickness, can be deposited on a substrate without the formation of cracks or development of a haze. The coating is highly transparent and is an effective diffusion barrier for oxygen and water.

The silanes have the formula R₍₄₋ₙ₎SiXₙ where: n is 1 to 4; X is independently a hydrolyzable group selected from C₁ to C₆ alkoxy, Cl, Br, I, hydrogen, C₁ to C₆ acyloxy, and NR′R″ where R′ and R″ are independently H or C₁ to C₆ alkyl, C(O)R″', where R″' is independently H, or C₁ to C₆ alkyl; and R is independently C₁ to C₁₂ radicals, optionally with one or more heteroatoms, including 0, S, NH, and NR″″ where R″″ is C₁ to C₆ alkyl or aryl, wherein the radical is non-hydrolyzable from the silane and contains a group, capable of undergoing polyaddition or polycondensation reactions, selected from Cl, Br, I, unsubstituted or monosubstituted amino, amido, carboxyl, mercapto, isocyanato, hydroxyl alkoxy, alkoxycarbonyl, acyloxy, phosphorous acid, acryloxy, metacryloxy, epoxy, vinyl, alkenyl, or alkynyl. Exemplary silanes for inclusion of the sol that produces the composite hybrid coating are tetraethoxysilane (TEOS) and γ-glycidoxypropyltrimethoxysilane (GPTMS).

The hydrolyzable metal oxide precursor has the formula MXₙ, where: n is 2 to 4; M is a metal selected from the group consisting of Ti, Zr, Al, B, Sn, and V; and X is a hydrolyzable moiety selected from the group C₁ to C₆ alkoxy, Cl, Br, I, hydrogen, and C₁ to C₆ acryloxy. An exemplary hydrolyzable metal oxide precursor for inclusion of the sol that produces the composite hybrid coating is comprises titanium tetrabutoxide (TTB).

The nanoparticles can be oxides, oxide hydrates, nitrides, or carbides of Si, Al, B, Ti, or Zr in the shape of spheres, needles, or platelets. The nanoparticles have a cross-section, or diameter, of from 2 to 50 nm. Exemplary nanoparticles for dispersion in the sol to form the composite hybrid coating are boehmite nanoplatelets.

In another embodiment, the invention is directed to a method of preparing a coating where: a sol is derived from a solution of water in a miscible organic solvent that contains at least one hydrolyzable silane, with at least one silane containing a polymerizable organic group attached to the silane; adding a second solution containing a hydrolyzable metal oxide precursor to the sol; dispersing nanoparticles in the sol to from a dispersion; coating a substrate with the dispersion; and gelling the dispersion upon a substrate to yield a transparent coating with a thickness of at least 5 μm. For example, a sol can be formed by combining water, ethanol, and tetraethoxysilane (TEOS) and γ-glycidoxypropyl-trimethoxysilane (GPTMS) to hydrolyze the alkoxy groups from the silanes, and subsequently adding titanium tetrabutoxide to the sol mixture. After all of the components of the sol have been combined, a suspension of boehmite nanoplatelets is added to the sol to form a dispersion that is coated on a substrate and heated to gel and cure the thick transparent coating. The coating can be deposited on a plastic or other organic material by dipping, spreading, brushing, knife coating, rolling, spraying, spin coating, screen printing and curtain coating. The loss of volatiles and curing of the coating can be carried out by heating the coated substrate up to the temperature, but not in excess of the temperature, where deformation of the substrate occurs. The substrate can be an organic material such as a thermoplastic.

### BRIEF DESCRIPTION OF THE DRAWINGS

FIGS. 1(a) and 1(b) are compositional graphs of GPTMS-TTB-TEOS compositions according to an embodiment of the invention where the composition region that affords transparent films are indicated by dashed lines, and where a molar ratio of H₂O to Si used for hydrolysis of the metal alkoxide is 6 (a) or 3 (b).

FIG. 2 shows the overlay of FTIR spectra for a 60-30-10 GPTMS-TTB-TEOS sol-gel coating composition according to an embodiment of the invention at various times (0, 0.5, 1.33, and 24 hours). The loss of the SiOCH₃ group and the epoxy group is indicated by the decrease in the peaks at 2840, 910, and 855 cm⁻¹.

FIG. 3 shows an overlay of UV-VIS spectra for boehmite sol-gel hybrid films according to an embodiment of the invention containing 0, 40, and 60 weight percent boehmite platelets, where nearly 100 percent transmission is observed from about 400 to 800 nm.

FIG. 4 shows nano indention curves for 0, 30, 40 and 60 weight percent boehmite sol-gel hybrid films according to an embodiment of the invention.

FIG. 5 shows a plot of the modulus for various boehmite sol-gel hybrid films having various weight percent boehmite platelets according to an embodiment of the invention.

FIG. 6 shows a graph of water vapor transmission rates through: 100 μm PET film; 12 μm silica coated PET film (PET/SiOx PVD layer); 40 wt% boehmite nanoparticle containing sol-gel hybrid coating on 100 μm PET film; 60 wt% boehmite nanoparticle containing sol-gel hybrid coating on 100 μm PET film and 40 wt% boehmite nanoparticle containing sol-gel hybrid coating on 12 μm silica coated PET substrate (PET/SiOx PVD layer).

FIG. 7 shows a graph of oxygen transmission rates through: 100 μm PET film; 12 μm silica coated PET film (PET/SiOx PVD layer); 40 wt% boehmite nanoparticle containing sol-gel hybrid coating on 100 μm PET film; 60 wt% boehmite nanoparticle containing sol-gel hybrid coating on 100 μm PET film and 40 wt% boehmite nanoparticle containing sol-gel hybrid coating on 12 μm silica coated PET substrate (PET/SiOx PVD layer).

### DETAILED DESCRIPTION OF THE INVENTION

Embodiments of the invention are directed to novel hard transparent coatings for plastics, other organic substrates, or other substrates, such as metals, that can be fabricated without the use of vacuum techniques and can be cured without the need of temperatures in excess of a temperature where deformation of the substrate can occur. The novel coatings involve formation of a composite hybrid coating comprising nanoparticles of less than 100 nm in diameter that are suspended without the significant aggregation that can lead to the loss of transparency at a high solids loading in a sol-gel derived matrix. The cured coating can be applied as a single coating layer to a thickness in excess of 5 μm, yet still display a transparency of more than 95% to visible light, and having no cracks or other discernable defects. Water permeability of less than 0.1 g/m²/d are formed upon curing the coating.

The novel composite hybrid coatings are formed from the hydrolysis and condensation of a coating formulation comprising at least one hydrolyzable silane, at least one hydrolyzable metal oxide precursor, at least one nanoparticle, water, at least one solvent, optionally a catalyst, and optionally one or more additives. The composition can be applied to a variety of substrates, and is useful on transparent substrates due to the coatings high transparency.

The hydrolyzable silane can be any compound or a mixture of compounds with the formula R₍₄₋ₙ₎SiXₙ, where: n is 1 to 4; X is independently a hydrolyzable group including C₁ to C₆ alkoxy, Cl, Br, I, hydrogen, C₁ to C₆ acyloxy, NR′R″ where R′ and R″ are independently H or C₁ to C₆ alkyl, C(O)R′″, where R′″ is independently H, or C₁ to C₆ alkyl; and R is independently C₁ to C₁₂ radicals, optionally with one or more heteroatoms, including O, S, NH, and NR″″ where R″″ is C₁ to C₆ alkyl or aryl, wherein the radical is non-hydrolyzable from the silane and contains a group capable of undergoing a polyaddition or polycondensation reaction, including Cl, Br, I, unsubstituted or monosubstituted amino, amido, carboxyl, mercapto, isocyanato, hydroxyl alkoxy, alkoxycarbonyl, acyloxy, phosphorous acid, acryloxy, metacryloxy, epoxy, vinyl, alkenyl, or alkynyl. Although n can be 1 to 4, the average n of the mixture should be greater than 2, and generally at least 3. A particularly useful R group is γ-glycidoxypropy, where for example, the compound of formula R₍₄₋ₙ₎SiXₙ, is γ-glycidoxypropyltrimethoxysilane (GPTMS) or γ-glycidoxypropyltriethoxysilane. Additionally, the inclusion of hydrolyzable silanes, where n is 4, for example, tetraethoxysilane (TEOS), is advantageous for the development of desired properties of the coatings.

The hydrolyzable metal oxide precursor is a compound of the formula MXₙ, where: n is 2 to 4; M is a metal selected from the group consisting of Ti, Zr, Al, B, Sn, and V; and X is a hydrolyzable moiety selected from the group C₁ to C₆ alkoxy, Cl, Br, I, hydrogen, and C₁ to C₆ acryloxy. Ti, Al, and Zr are preferred metals.

Typically, a coating formulation according to the invention is prepared by combining the hydrolyzable components in one or two steps with the water. For example, the silanes can be combined with water and hydrolysis can be promoted for any desired period of time before the hydrolyzable metal oxide precursor and any additional water is introduced to the coating formulation. The water content of the coating formulations of the present invention can be at a level of 0.2 to 6 times the number of equivalents of hydrolyzable groups in the coating formulation. Preferably water is included at a level of 0.5 to 3 times the number of equivalents of hydrolyzable groups. The coating formulation generally includes a solvent. The solvent is effectively inert and can be a mixture of solvents. Generally, when the silanes and metal oxide precursor are alkoxides, an alcohol is included in the coating formulation, where, even if alkoxy exchange processes occur, the net reaction is no addition of the alcohol to the silanes or metal oxide precursor.

Inert solvents can be added to the coating composition at any step of the coating process to modify the rheological properties of the composition. Alcohols are generally effectively inert in the process and can be the alcohol formed by hydrolysis/and or condensation of any alkoxysilane or metal alkoxide used in the coating formulation.

The nanoparticles are selected from the oxides, oxide hydrates, nitrides, and carbides of Si, Al, B, Ti, and Zr. The nanoparticle can be from 1 to 100 nm in diameter, preferably from 2 to 50 nm in diameter and more preferably from 5 to 20 nm in diameter. The nanoparticles can be included in the coating composition as a powder, or as a sol in an aqueous or non-aqueous solvent. Among the nanoparticles for use in the invention are SiO₂, TiO₂, ZrO₂, Al₂O₃, Al(O)OH, and Si₃N₄. Of particular utility is the boehmite form of aluminum oxide. The nanoparticles can be in the shape of spheres, needles, platelets, or any other shape. Particularly useful particles are platelets or other relatively flat particles (high aspect ratio) such that partial or complete orientation of the relatively flat surface of the particle can be parallel to the surface of the substrate. The nanoparticles can be included in the coating formulation at 3 to 90 percent of the solid content of the ultimate cured coating, preferably 30 to 75 percent and more preferably 40 to 70 percent. The particle can be dispersed in the coating formulation from polar solvents, such as DMF, DMSO, and water. Before dispersion of the nanoparticles, their surface can be modified. A silane modified particle, particularly epoxysilane modified particles, can be employed in embodiments of the invention. Surfactants can be included for the formation of stable dispersions of the nanoparticles. The surfactants can include: nitric acid, formic acid, citric acid, ammonium citrate, ammonium polymethacrylate, and silanes. While preparing a coating formulation, the nanoparticles can be added as a dispersion in a solvent to the curable components.

A catalyst for hydrolysis of the hydrolyzable groups and their subsequent condensation can be included in the coating formulation as needed. The catalyst can be an acid or a base, but is generally an acid. For example the acid can be nitric acid. Additional catalyst for the polyaddition or polycondensation reaction of some or all of the R groups of the silanes can be included in the coating formulation. The catalyst can be a photoinitiator. Optional components that can be included, separately or in combination, in the coating formulation, to achieve the desired coating properties and curing profiles, are colorants, leveling agents, UV stabilizers, and photosensitizers.

A substrate can be coated by any method amenable to the coating formulation of the invention, including dipping, spreading, brushing, knife coating, rolling, spraying, spin coating, screen printing and curtain coating. Depending on the substrate, its surface may require activation or deposition of a base coat for good adhesion to the coating of the invention. Methods such as corona treatment, plasma treatment, chemical treatment, or the deposition of adhesion promoters can be used to promote a robust adhesion of the inventive coating to a plastic substrate. Some removal of solvents can be carried out at room temperature prior to beginning a curing sequence. The curing of the coating can be carried out at temperatures of 50 to 300° C., and preferably from 90 to 180° C., and more preferably from 90to 130° C. Upon curing and loss of volatiles, coatings of 1 to 30 μm results, preferably from 2 to 20 μm and more preferably from 5 to 15 μm. Where a photoinitiator is included, the irradiation can be carried out prior to, during, or after thermal curing. In many embodiments using a photoinitiator, photoinitiation is advantageously carried out prior to heating.

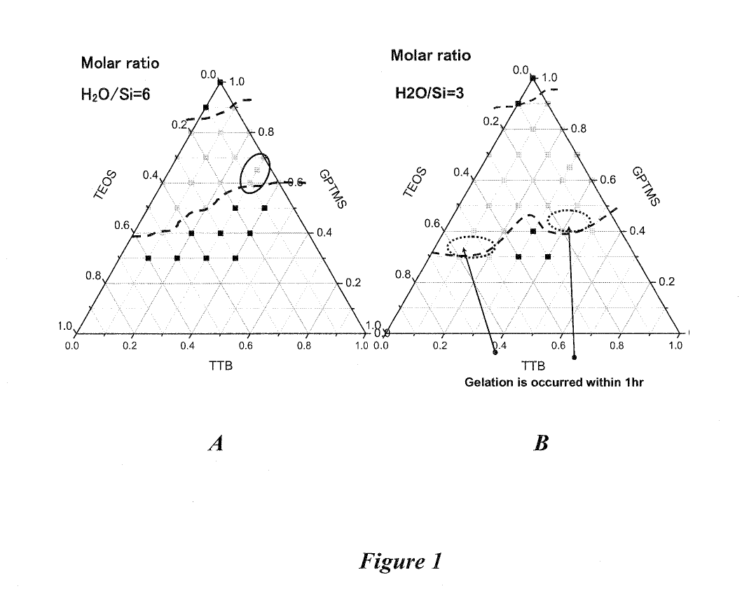

In one embodiment of the invention the coating formulation includes titanium tetrabutoxide (TTB), γ-glycidoxypropyltrimethoxysilane (GPTMS), tetraethoxysilane (TEOS), boehmite nanoparticles and water. The weight fraction of boehmite nanoparticles in the resulting coating can be as high as about 80 weight percent without the formation of large aggregates of the nanoparticles. The composition of the fluid portion of the coating composition can have a molar ratio of water to silicon of about 2 to about 6. The TTB can be from about 0 to 55 mole percent of the total metals in the fluid mixture. The GPTMS can be from about 35 to 90 mole percent of the total metals in the fluid mixture. The TEOS can be from about 0 to 60 mole percent of the total metals in the fluid mixture. The molar ratio of TEOS to GPTMS can range from 0 to about 2.0. The mole percentage of the various metal containing components in the fluid mixture depends on the ratio of water to silicon in the mixture. Generally, the lower the water content, the higher the titanium content can be in the fluid mixture. FIG. 1 displays proportions of the metal alkolate components for the coating composition of this embodiment of the invention that allow the formation of a transparent sol-gel coating upon curing. Additionally, the fluid mixture can include one or more alcohols, for example ethanol, to mediate the hydrolysis and condensation of the system. Catalyst, such as a mineral acid, can be added with the water. Other solvents, for example dimethylformamide (DMF), can be included in the formulation.

In other embodiments of the invention other equivalents to GPTMS, TTB, and TEOS can be used, for example: any glycidoxypropyltralkoxysilane, where the alkoxy group is 6 carbons or less, can be substituted for GPTMS; any tetraalkoxysilane, where the alkoxy group is 6 carbons or less, can be substituted for TEOS; and any titanium tetraalkoxide, where the alkoxy group is 6 carbons or less, can be substituted for TTB. Alcohols other than ethanol can be incorporated into the coating formulation, and any alcohol of 6 carbons or less can be used.

The inventors discovered that the transparency of the coating is highly dependent on the mode of addition of the components during formation of the sol. In one embodiment, the GPTMS and any TEOS are combined in ethanol, to which water and HCl are added. This fluid mixture is held at room temperature until at least some hydrolysis occurs, after which TTB in an ethanol solution is added. This mode of addition results in a coating solution that is transparent. If no hydrolysis of the alkoxysilanes occurs prior to introduction of the TTB, the TTB will selectively hydrolyze and condense, forming a titania rich precipitate that precludes the possibility of formation of a transparent coating. By dip coating a substrate in the transparent coating solution from GPTMS, TEOS and TTB, a transparent thick film results upon curing when heated to less than 150° C. The coating from a formulation having an ethanol to silicon molar ratio of 1 to 10 will have a film thickness of from about 5 to about 8 μm.

Hydrolysis, condensation and ring-opening processes can be promoted by heating the coating mixture. Heating can essentially achieve complete cure. The epoxy ring-opening occurs upon heating. The process can be carried out at any temperature, generally to about the glass transition temperature of the substrate, for example, 143° C. for a polycarbonate substrate, or a temperature not significantly in excess of the boiling point of a hydrolyzable component in the starting formulation, for example, 165° C. for TEOS. Additionally, catalysts can be added for the hydrolysis and condensation of the alkoxysilanes and alkoxytitanates, for the ring-opening of epoxy groups of the GPTMS, or its equivalent, either by an alcohol or water, and/or for the condensation of nucleophilic oxygens from the ring-opened epoxy groups with the Si or Ti atoms in the gelling mixture. The catalyst can reduce the temperature that is required to cure the coating formulation to a glass. The catalyst can be a photocatalyst.

In other embodiments of the invention, the TTB can be substituted with a different metal alkoxides. For example, titania precursors, such as TTB can be fully or partially substituted with alumina, zirconia, or other metal oxide precursors. Mixtures of different metal alkoxides can be employed. In general, the alkoxysilanes will have lower rates of hydrolysis and condensation than that of other metal alkoxides. In these embodiments of the invention, some hydrolysis of the alkoxysilane mixture should be carried out prior to addition of the other metal oxide to avoid precipitation of a silicate poor metal oxide that results in the loss of transparency.

Boehmite nanoplatelets are nanoparticles of Al(O)OH with an aspect ratio of about 10 to about 20. Such nanoplatelets can be dispersed in water or in some organic solvents. For example, a 70 weight percent dispersion of boehmite nanoplatelets in dimethylformamide (DMF) can be prepared that is stable and has a small sized aggregate of about 60-80 nm. In embodiments of the invention, boehmite nanoplatelet dispersions in an organic solvent are added to the sol from the alkoxysilane-metal alkoxide mixture to form a boehmite dispersed hybrid sol. The substrate can then be coated with the dispersion and subsequently heated to gel and cure the hybrid coating.

A wide variety of substrates can be coated. The substrates can be any solid material that can be heated to temperatures of about 100° C. or more without decomposition or deformation. In particular, organic materials can be used. In one embodiment, the substrate is a transparent thermoplastic, for example, polycarbonate (PC), polyethylenterephthalate (PET), polyethylenenaphthalate (PEN), or polymethylmethacrylate (PMMA). The gelation of the coating can be promoted at any temperature up to about 150° C., or higher when the thermal transitions of the substrate permit. In some embodiments of the invention, gelation can be promoted by a catalyst at a temperature below 100° C., for example, using a photochemically generated acid. In one embodiment reaction of the organic functional group on a silane can occur photochemically when an appropriate catalyst or initiator is included, while the condensation of the hydrolyzed metal alkoxides occurs exclusively thermally. For example, if an olefin substituent is included on a silane incorporated in the reaction mixture, the vinyl addition reaction may be carried out photochemically with inclusion of an appropriate photoinitiator, such as a radical photoinitiator, while the condensation of the metal alkoxide groups, such as alkoxysilane and alkoxytitanate groups undergo a thermally induced hydrolysis and condensation.

### METHODS AND MATERIALS

### Preparation of Boehmite-Free Sol-Gel Coatings

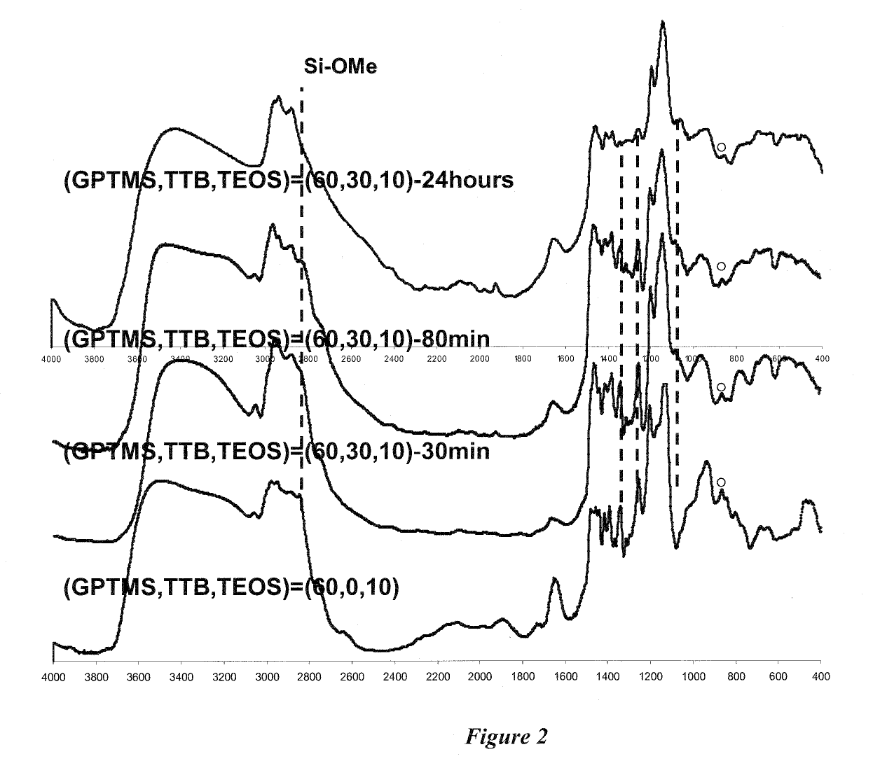

Fluid sol-gel mixture was prepared by adding various molar proportions of GPTMS in ethanol with TEOS. The mixture was stirred and 0.001N HCl solution was added such that the molar ratio of water to Si was either 6 or 3. The hydrolysis was monitored by FT IR and Raman spectroscopy, where, as shown in FIG. 2, little epoxy ring-opening was apparent during the first 80 minutes after addition of the TTB, based on the persistence of the IR band at 910 cm⁻¹, while a substantial portion of the methoxysilyl groups were hydrolyzed, as indicated by the loss of the peak at 2840 cm⁻¹. To the sol-gel mixture was added various amounts of TTB in ethanol. Stirring was continued for 2 hours. No precipitation was observed. Thick transparent films of the mixture could be formed by dip-coating a glass substrate into the sol-gel mixture. After removal the coated substrate was heated to 120° C. for 2 hours. The proportions of the reagents for various sol-gel mixtures, as well as the thickness and hardness of the coatings resulting from these mixtures, are given below in Table 1. The thickness of the coating increased with the proportion of tetraalkoxy components in the coating formulation, but in all cases hard films resulted.

### Properties of Transparent Boehmite-Free Sol-Gel Coatings

| Molar Proportions of | | | | | |
|---|---|---|---|---|---|
| Metal Alkoxides | | | Molar Ratio | Thickness | Pencil |
| GPTMS | TEOS | TTB | H₂O/Si | in μm | Hardness |
| 60 | 10 | 20 | 6 | 5.3 | >4H |
| 60 | 20 | 20 | 6 | 5.9 | >4H |
| 60 | 10 | 30 | 6 | 6.7 | >4H |
| 50 | 10 | 40 | 3 | 7.8 | >4H |

### Preparation of Boehmite Sol-Gel Hybrid Coatings

A composition, for the formation of a hybrid film on a substrate, was prepared by the combination of a solution of 1.26 g of TEOS in 2 g of ethanol with 2.5 g of 0.001N aqueous HNO₃. To this mixture was added 10 g of GPTMS and the mixture stirred at room temperature for two hours to form a silica sol. A solution of 4.1 g of TTB in 2 g of ethanol was added with stirring to the silica sol and the mixture was stirred for an additional two hours. To this sol mixture was added 12.5 g of boehmite platelets in 25 g of dimethylformamide. A PET film substrate was dip coated with the boehmite-sol dispersion. The coated PET was heated to 120° C. for 2.5 hours to form a hybrid film with a thickness of 6 μm deposited on each face of the substrate and a weight percent of boehmite platelets of 60. In like manner, hybrid films with 30, 40, 50, and 70 weight percent were formed.

### Optical Properties of Boehmite Sol-Gel Hybrid Coatings

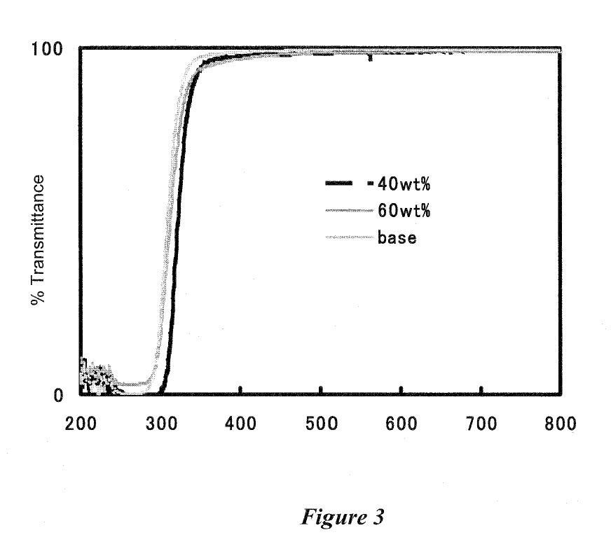

FIG. 3 shows the UV-VIS spectra of coatings containing 0, 40, and 60 weight percent of boehmite nanoplatelets, that were prepared as described above. As can be seen in FIG. 3, the films are highly transparent through the visible spectrum.

### Mechanical Properties of Boehmite Sol-Gel Hybrid Coatings

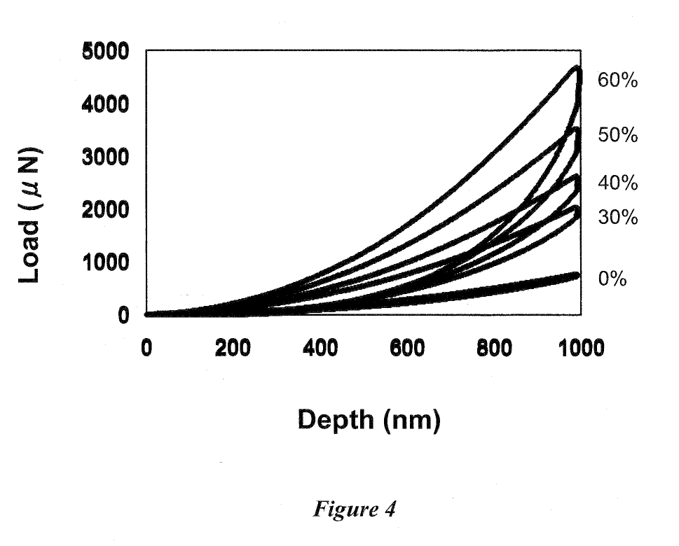

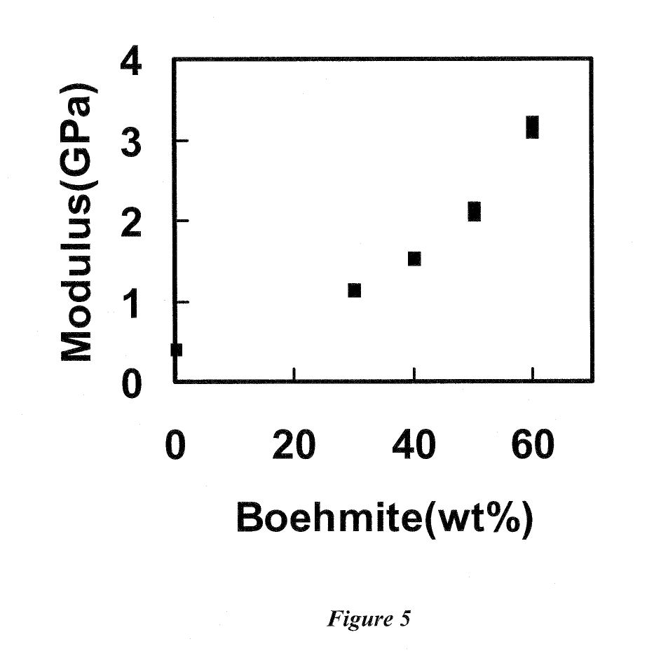

Nano indentation was measured using a Hysitron TriboIndenter to measure the mechanical properties of the boehmite sol-gel hybrid coatings. In this process an indenter tip was driven into the sample by applying an increasing load, followed by decreasing the load until partial or complete relaxation of the hybrid film occurred. The resulting load-depth curves for 0, 30, 40, 50 and 60 percent boehmite containing sol-gel hybrid films are shown in FIG. 4. The moduli were calculated from the load-depth curves, which are given in FIG. 5. As can be seen in FIG. 5, the addition of 30% boehmite platelets more than doubles the modulus of the boehmite-free sol-gel film. Increasing the boehmite to 60 weight percent in the cured film, results in a six fold increase in the modulus relative to the boehmite-free sol-gel film. The coatings were transparent for all loadings of boehmite platelets.

### Barrier Properties of Boehmite Sol-Gel Hybrid Coatings

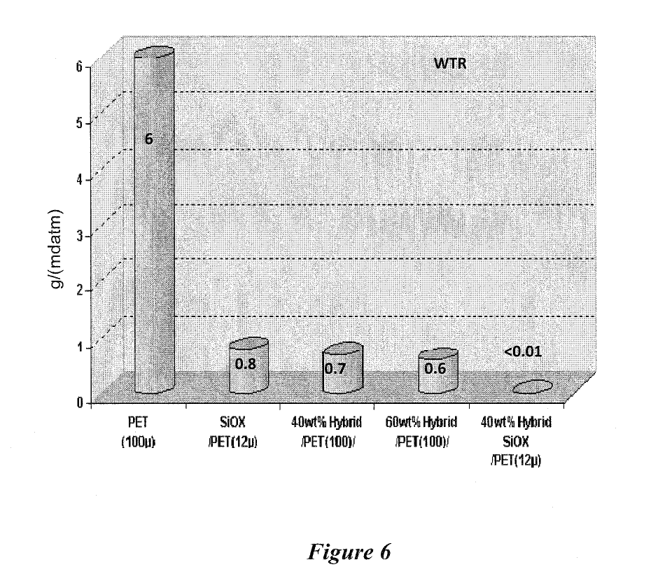

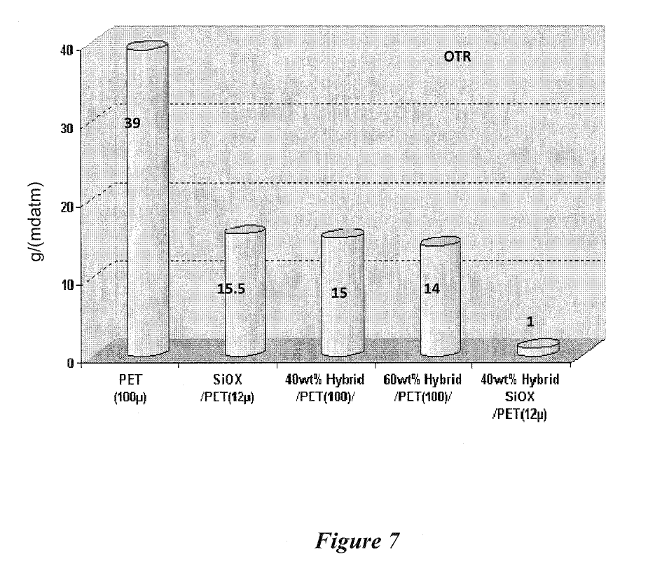

Barrier properties were measured using a differential pressure method, where an air or other gas flows at constant pressure in a chamber in contact with one face of a sheet of the coated substrate, and the opposite face of the sheet is directed to a chamber that is under vacuum. The gases that permeate through the film and substrate are collected on the vacuum side and measured using gas chromatography. Diffusion studies were carried out on the water and O₂ transmission rates through a 100 μm PET film, a 12 μm commercial silica coated PET film, 40 wt%, and 60 wt% boehmite nanoparticle containing sol-gel hybrid coated on the 100 μm PET substrate and 40 wt% boehmite nanoparticles containing sol-gel hybrid coated on the 12 μm silica coated PET film The silica layers were applied by physical vapor deposition. The results are shown in the graphs of FIG. 6 and FIG. 7 for water vapor and oxygen, respectively.

Water transmission rates decreased by about an order of magnitude after the substrates were coated with the boehmite nanoparticle containing sol-gel hybrid. The oxygen transmission rate also decreased to less than half of that of the substrate by coating with the boehmite sol-gel hybrid coatings. As can be seen in FIGS. 6 and 7, the barrier properties of the boehmite nanoparticle containing sol-gel hybrid coatings are equivalent or superior to those of conventional silica layers formed by physical vapor deposition, yet is more easily applied to a substrate as the nanoparticle containing sol-gel hybrid coatings do not require the use of vacuum for application. The nanoparticle containing sol-gel hybrid coatings are applied under ambient conditions of either low or high humidity, which is a lower cost method for formation of a barrier layer than vapor deposition.

FIGS. 6 and 7 also illustrate that the novel nanoparticle containing sol-gel hybrid coatings with their intrinsic barrier properties significantly improves the barrier properties of a polymeric substrate already possessing an inorganic barrier layer. The combination of the physical vapor deposition silica coating and the boehmite nanoparticles containing sol-gel hybrid coating resulted in more than an order of magnitude improvement of water and oxygen transmission over either single coating layer.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A transparent composite hybrid coating comprising:
a sol-gel glass wherein said glass is derived from a mixture comprising at least one hydrolyzable silane, wherein at least one of said silanes contains at least one polymerizable organic group attached to the silane, and at least one hydrolyzable metal oxide precursor; and
a plurality of nanoparticles of less than 100 nm in diameter, wherein upon complete cure said coating has a thickness of at least 5 μm.

2. The coating of claim 1, wherein said silanes comprise R₍₄₋ₙ₎SiXₙ, where:
n is 1 to 4;
X is independently a hydrolyzable group selected from C₁ to C₆ alkoxy, Cl, Br, I, hydrogen, C₁ to C₆ acyloxy, and NR′R″ where R′ and R″ are independently H or C₁ to C₆ alkyl, C(O)R′″, where R′″ is independently H, or C₁ to C₆ alkyl; and
R is independently C₁ to C₁₂ radicals, optionally with one or more heteroatoms, including O, S, NH, and NR″″ where R″″ is C₁ to C₆ alkyl or aryl, wherein said radical is non-hydrolyzable from said silane and contains a group capable of undergoing polyaddition or polycondensation reactions, selected from Cl, Br, I, unsubstituted or monosubstituted amino, amido, carboxyl, mercapto, isocyanato, hydroxyl alkoxy, alkoxycarbonyl, acyloxy, phosphorous acid, acryloxy, metacryloxy, epoxy, vinyl, alkenyl, or alkynyl.

3. The coating of claim 1, wherein said silanes comprise tetraethoxysilane (TEOS) and γ-glycidoxypropyltrimethoxysilane (GPTMS).

4. The coating of claim 1, wherein said silane comprises γ-glycidoxypropyltrimethoxysilane (GPTMS).

5. The coating of claim 1, wherein said metal oxide precursor comprises MXₙ where:
n is 2 to 4;
M is a metal selected from the group consisting of Ti, Zr, Al, B, Sn, and V; and
X is a hydrolyzable moiety selected from the group C₁ to C₆ alkoxy, Cl, Br, I, hydrogen, and C₁ to C₆ acryloxy.

6. The coating of claim 1, wherein said metal oxide precursor comprises titanium tetrabutoxide (TTB).

7. The coating of claim 1, wherein said nanoparticles comprise oxides, oxide hydrates, nitrides, or carbides of Si, Al, B, Ti, or Zr in the shape of spheres, needles, or platelets.

8. The coating of claim 1, wherein said nanoparticles comprise SiO₂, TiO₂, ZrO₂, Al₂O₃, Al(O)OH, Si₃N₄ or mixtures thereof.

9. The coating of claim 1, wherein said nanoparticles are from 2 to 50 nm in diameter.

10. The coating of claim 1, wherein said nanoparticles are from 5 to 20 nm in diameter.

11. The coating of claim 1, wherein said nanoparticles comprise boehmite platelets.

12. A method for coating a substrate with a transparent composite hybrid comprising the steps of:
providing a sol derived from a water comprising solution and at least one hydrolyzable silane, wherein at least one of said silanes contains at least one polymerizable organic group attached to said silane;
adding a second solution comprising at least one hydrolyzable metal oxide precursor to said sol;
dispersing a plurality of nanoparticles in said sol to from a dispersion;
coating a substrate with said dispersion; and
gelling said dispersion upon said substrate, wherein said resulting coating is transparent to visible light with a transmittance of at least 85% at a thickness of at least 5 μm.

13. The method of claim 12, wherein said silane comprises an alkoxysilane comprising at least one alkoxysilane wherein at least one of said alkoxysilanes has at least one glycidoxypropyl group.

14. The method of claim 12, wherein said silanes comprise tetraethoxysilane (TEAS) and γ-glycidoxypropyltrimethoxysilane (GPTMS).

15. The method of claim 12, wherein said silane comprises γ-giycidoxypropyltrimethoxysilane (GPTMS).

16. The method of claim 12, wherein said hydrolyzable metal oxide precursor comprises a metal alkoxide.

17. The method of claim 12, wherein said hydrolyzable metal oxide precursor comprises titanium tetrabutoxide (TTB).

18. The method of claim 12, wherein said nanoparticles comprise boehmite nanoplatelets.

19. The method of claim 12, wherein a solvent in said water comprising solution comprises ethanol.

20. The method of claim 12, wherein said step of dispersing comprises adding a dispersion of said nanoparticle in a solvent.

21. The method of claim 20, wherein said nanoparticles comprise boehmite nanoplatelets and said solvent comprises DMF.

22. The method of claim 12, wherein said step of coating comprises dipping, spreading, brushing, knife coating, rolling, spraying, spin coating, screen printing and curtain coating.

23. The method of claim 12, wherein said step of gelling comprises heating said dispersion coated substrate.

24. The method of claim 23, wherein said heating is to a temperature less than 180° C.

25. The method of claim 12, wherein said substrate comprises an organic material.

26. The method of claim 25, wherein the organic material comprises a thermoplastic
